(19) United States
(12) Patent Application Publication
(10) Pub. No.: US 2011/0298995 A1
(43) Pub. Date: Dec. 8, 2011

(54) VIDEO PROJECTOR

(75) Inventor: Yosuke Nishihata, Hirakata-shi (JP)

(73) Assignee: SANYO ELECTRIC CO., LTD., Osaka (JP)

(21) Appl. No.: 13/154,062

(22) Filed: Jun. 6, 2011

(30) Foreign Application Priority Data
Jun. 8, 2010 (JP) 2010-131295

(51) Int. Cl. H04N 5/64

(52) U.S. Cl. 348/789; 348/E09.025

(57) ABSTRACT

A video projector including a housing to which an air filter is coupled in a removable manner. A brush cleans the air filter. A dust box collects dust from the brush and includes an opening that opens toward the brush. A handle is arranged on the housing so that the opening of the dust box is oriented upward when the handle is grasped to lift the housing.

### CROSS-REFERENCE TO RELATED APPLICATIONS

This application is based upon and claims the benefit of priority from prior Japanese Patent Application No. 2010-131295, filed on Jun. 8, 2010, the entire contents of which are incorporated herein by reference.

### BACKGROUND OF THE INVENTION

The present invention relates to a video project including a housing provided with a handle.

Japanese Laid-Open Patent Publications 2002-107816 and 2010-20059 describe video projectors provided with handles. In each projector, the handle is arranged on a housing. A person may easily carry the projector by holding the handle.

The housing of a typical projector includes an air filter that captures dust from the air drawn into the housing. Japanese Laid-Open Patent Publication No. 2007-156186 describes a projector including a brush that moves straight in a predetermined direction to clean an air filter. Japanese Laid-Open Patent Publication No. 2008-65021 describes a projector including a filter unit. A brush is fixed to the filter unit, and the filter is moved relative to the brush to clean a filter.

The brush collects dust when cleaning the air filter. It is preferable that the dust be removed from the brush to prevent the cleaning capability of the brush from being lowered. It is further preferable that the dust removed from the brush be collected in a dust box so that the dust does not return to the housing. In this manner, in a projector including a brush that cleans an air filter, it is preferable that a dust box, which has an opening facing toward the brush, be provided to collect dust from the brush in order to increase the cleaning efficiency of the air filter.

However, when carrying the projector, the opening of the dust box may be directed in a downward direction. In such a case, dust may fall out of the dust box through the opening. In particular, when the housing includes a handle, the handle would be used to carry the projector. Thus, depending on the location of the handle, the opening of the dust box may be directed in a downward direction.

### SUMMARY OF THE INVENTION

One aspect of the present invention is a video projector including a housing to which an air filter is coupled in a removable manner. A brush cleans the air filter. A dust box collects dust from the brush and includes an opening that opens toward the brush. A handle is arranged on the housing so that the opening of the dust box is oriented upward when the handle is grasped to lift the housing.

Another aspect of the present invention is a video projector including a housing to which an air filter is coupled in a removable manner. A brush cleans the air filter. A dust box collects dust from the brush and includes an opening that opens toward the brush. A plurality of handles are arranged on the housing. The plurality of handles include at least one first handle and at least one second handle. The at least one first handle is arranged on the housing so that the opening of the dust box is oriented upward when the at least one first handle is grasped to lift the housing. An indication indicates that the at least one first handle is to be preferentially grasped over the at least one second handle.

A further aspect of the present invention is a video projector including a housing to which an air filter is coupled in a removable manner. A brush cleans the air filter. A dust box collects dust from the brush and includes an opening that opens toward the brush. A plurality of handles are arranged on the housing. The plurality of handles include at least one first handle and at least one second handle. The at least one first handle is arranged on the housing so that the opening of the dust box is oriented upward when the at least one first handle is grasped to lift the housing. The at least one second handle is arranged on the housing so that the opening of the dust box is oriented downward when the at least second one second handle is grasped to lift the housing. The video projector is formed so that its center of gravity is located closer to the at least one first handle than the at least one second handle.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing a video projector according to one embodiment of the present invention;

FIG. 2 is a plan view showing the video projector of FIG. 1;

FIG. 3 is a schematic diagram of an optical system in the video projector of FIG. 1;

FIG. 4 is a perspective view showing an air filter cleaning device removed from the video projector of FIG. 1;

FIG. 5 is a perspective view showing the air filter device of FIG. 4;

FIG. 6 is a plan view showing the air filter device of FIG. 5;

FIG. 7 is an exploded perspective view showing a cleaning unit arranged in the air filter device of FIG. 5;

FIG. 8 is a perspective view showing a dust box of FIG. 7 in an open state;

FIG. 9 is a cross-sectional view of the air filter device taken along line A-A in FIG. 6;

FIG. 10 is a perspective view showing the video projector of FIG. 1 when carried;

FIG. 11 is a schematic diagram showing the state of the air filter device in the video projector when carried as shown in FIG. 10;

FIG. 12 is a plan view showing a video projector according to a second embodiment of the present invention;

FIG. 13 is a schematic diagram of an optical system in the video projector of FIG. 12;

FIG. 14 is a plan view showing a video projector according to a third embodiment of the present invention;

FIGS. 15A and 15B are schematic diagrams showing the distance from the handle, which is held when carrying the video projector of FIG. 14, to the center of gravity and illustrate the moment of force about the handle that is produced when the video projector is swung;

FIG. 16 is a front view of a video projector including a modified handle;

FIG. 17 is a schematic diagram showing the state of a dust box when the video projector of FIG. 16 is carried; and

FIG. 18 is a schematic diagram showing a modified air filter device.

### DETAILED DESCRIPTION OF THE EMBODIMENTS

### First Embodiment

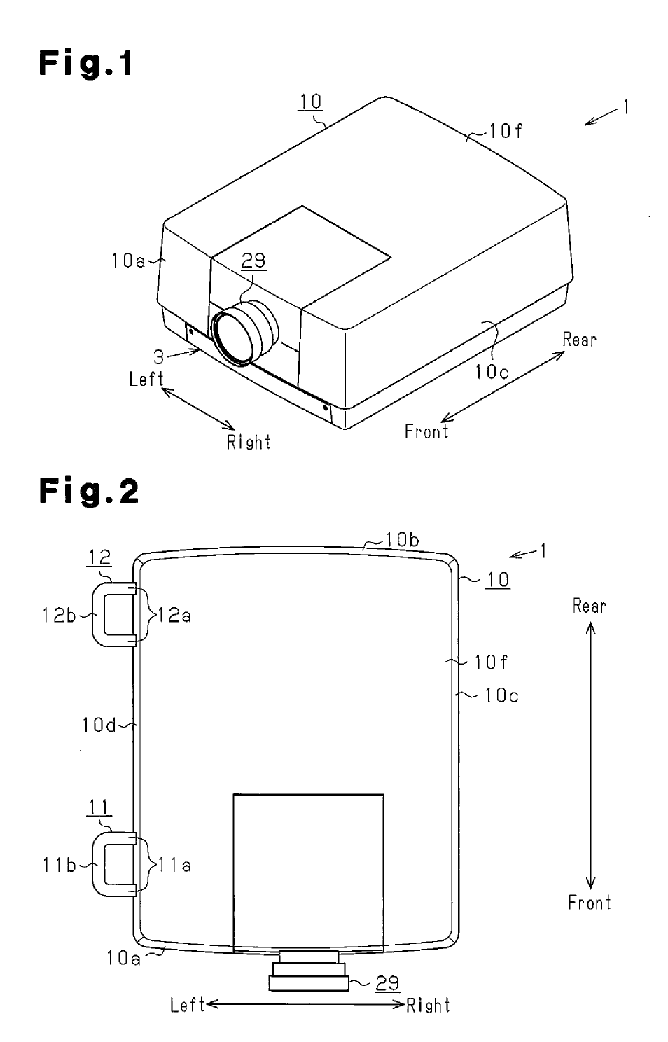

A projector 1 according to one embodiment of the present invention will now be discussed with reference to FIGS. 1 to 11.

As shown in FIG. 1, the projector 1 includes a housing 10, which accommodates electronic components and optical components. The projector 1 is a video projector that projects and displays images on a planar surface such as a screen or wall. In the description hereafter, the direction in which the projector 1 projects the light of an image is referred to as the frontward direction. When the projector 1 is arranged on a horizontal surface (not shown), the direction parallel to the horizontal surface and perpendicular to the frontward direction is referred to as the lateral direction.

As shown in FIGS. 1 and 2, the box-shaped housing 10, which is formed from a resin material, includes a front surface 10a and a rear surface 10b. When the projector 1 is arranged on a horizontal surface, the front surface 10a is located at the front of the housing 10 and the opposite rear surface 10b is located at the rear of the housing 10.

The housing 10 further includes a side surface 10c and a side surface 10d. When the projector 1 is arranged on a horizontal surface, the side surface 10c is located at the right of the housing 10 and the side surface 10d is located at the left of the housing 10. As shown in FIG. 2, two handles 11 and 12 are arranged on the side surface 10c.

The handle 11 includes, for example, two extensions 11a, which extend toward the left from the side surface 10d of the housing 10, and a grip 11b, which connects the two extensions 11a. Further, the handle 12 includes two extensions 12a, which extend toward the left from the side surface 10d of the housing 10, and a grip 12b, which connects the two extensions 12a. Accordingly, the grips 11b and 12b of the handles 11 and 12 extend toward the front, or in a longitudinal direction, of the projector 1.

The handles 11 and 12 are spaced apart from each other in the longitudinal direction of the projector 1. When the projector 1 is carried by a single person, the projector 1 may be easily carried by holding the grip 11b of the handle 11 with one hand and the grip 12b of the handle 12 with the other hand.

The handles 11 and 12 may be formed integrally with the housing 10 from the same material as the housing 10. Alternatively, the handles 11 and 12 may be formed from a material that differs from that of the housing 10 so that they may be coupled in a removable manner to the housing 10 or retracted into the housing 10. Further, the handles 11 and 12 do not have to be directly arranged on the housing 10.

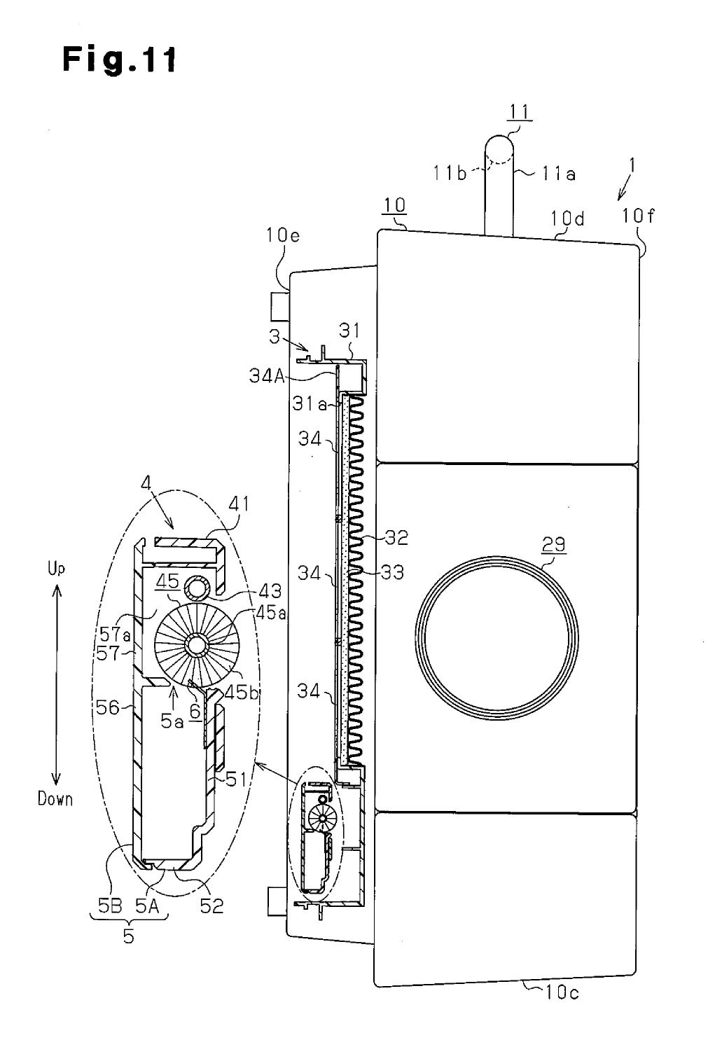

The housing 10 further includes a lower surface 10e (FIG. 11) and an opposite outer surface 10f. When the projector 1 is arranged on a horizontal surface, the lower surface 10e faces toward the horizontal surface. Accordingly, when the lower surface 10e is arranged at the lower side, the outer surface 10f is located at the upper side.

As shown in FIG. 2, the projector 1 includes an optical system 2, which is used to display an image. In the housing 10, the optical system 2 includes various optical components. Such optical components include lamps 21a, 21b, 21c, and 21d, dichroic mirrors 26r and 26b, and liquid crystal light valves 27r, 27g, and 27b. The lamps 21a, 21b, 21c, and 21d serve as a light source for displaying an image. The dichroic mirrors 26r and 26b separate white light into the three primary colors of light, namely, red light, green light, and blue light. The liquid crystal light valves 27r, 27g, and 27b respectively correspond to the three primary colors of light.

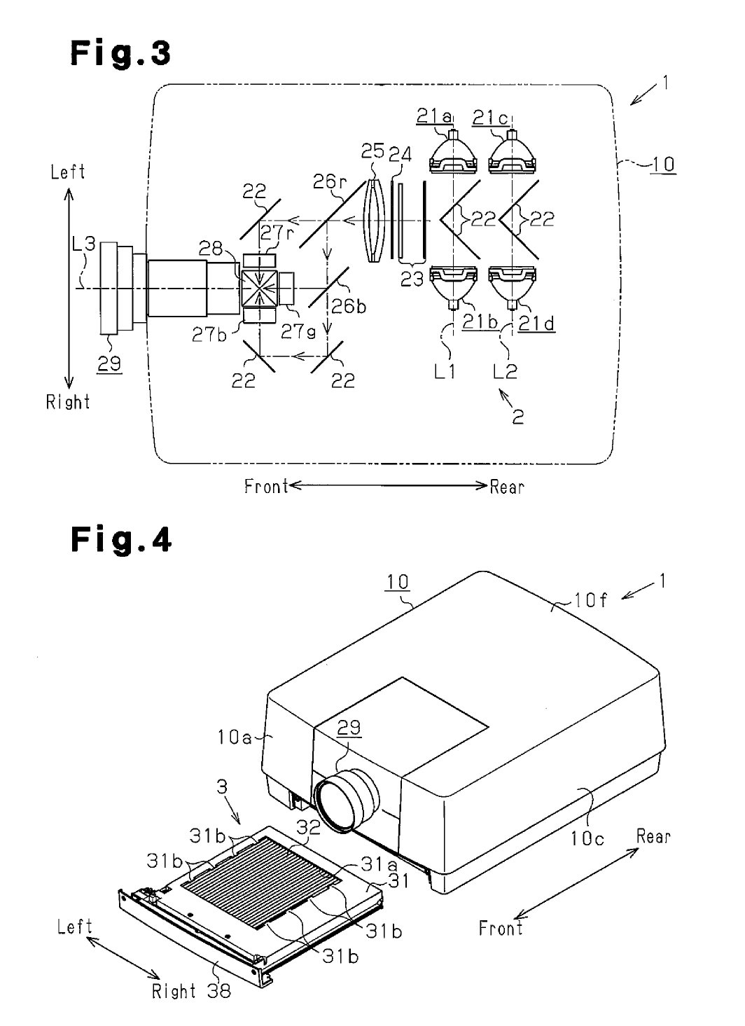

The lamps 21a, 21b, 21c, and 21d each emit white light as collimated light. Further, the lamps 21a, 21b, 21c, and 21d may each be formed by a discharge lamp, such as an ultrahigh pressure mercury lamp or metal halide lamp. As shown in FIG. 3, the lamp 21a has an optical axis L1 aligned with that of the lamp 21b. The lamp 21c has an optical axis L2 aligned with that of the lamp 21d. The two lamps 21a and 21b face toward each other in the lateral direction. The two lamps 21c and 21d face toward each other in the lateral direction. Accordingly, in the present embodiment, the lateral direction is the optical direction (direction parallel to the optical axes L1 and L2) of the lamps 21a, 21b, 21c, and 21d. The lamps 21a, 21b, 21c, and 21d are arranged so that the optical axis L1 is separated from the optical axis L2 when viewed from the front or the rear of the projector 1.

The light emitted from the lamps 21a, 21b, 21c, and 21d is reflected by corresponding full-reflection mirrors 22 and guided to the liquid crystal light valves 27r, 27g, and 27b. Here, until the light strikes the liquid crystal light valves 27r, 27g, and 27b, an integrator lens 23, which includes two fly's eye lens, realizes uniform illuminance distribution. Further, a polarizing beam splitter 24 sets the polarization direction in a predetermined direction. Moreover, a condenser lens 25 condenses the light that enters the liquid crystal light valves 27r, 27g, and 27b.

The dichroic mirror 26r, which transmits red light, and the dichroic mirror 26b, which transmits blue light, separate the white light emitted from the lamps 21a, 21b, 21c into red light, green light, and blue light.

The red light enters the liquid crystal light valve 27r. The liquid crystal light valve 27r is capable of varying the transmission rate of light for each pixel of an image and includes a liquid crystal panel or polarization plate (none shown). Transmission of the red light through the liquid crystal light valve 27r generates a red image.

The green light enters the liquid crystal light valve 27g. The liquid crystal light valve 27g is capable of varying the transmission rate of light for each pixel in the same manner as the liquid crystal light valve 27g. Transmission of the green light through the liquid crystal light valve 27g generates a green image.

The blue light enters the liquid crystal light valve 27b. The liquid crystal light valve 27b is capable of varying the transmission rate of light for each pixel in the same manner as the liquid crystal light valves 27r and 27g. Transmission of the blue light through the liquid crystal light valve 27b generates a blue image.

The housing 10 also includes a cross-dichroic prism 28 and a projection lens 29, which are optical components of the optical system 2. The cross-dichroic prism 28 combines the light of the red, green, and blue images. The projection lens 29 includes a group of lenses that project the light of an image.

The cross-dichroic prism 28 combines the light of the red, green, and blue images, which are generated by the liquid crystal light valves 27r, 27g, and 27b, to generate a full-color image of three or more colors. The light of the full-color image emitted from the cross-dichroic prism 28 enters the projection lens 29.

The projection lens 29 projects the light of the full-color image onto a flat surface arranged in front of the projector 1, such as a screen or a wall. As shown in FIG. 3, the projection lens 29 has an optical axis L3, and the projection lens 29 projects the light of an image about the optical axis L3. As viewed in FIG. 3 from a direction orthogonal to the longitudinal and lateral directions, the optical axis L3 of the projection lens 29 is orthogonal to the optical axes L1 and L2. The optical axis L3 and the optical axes L1 and L2 are parallel to the lower surface 10e.

To prolong the life of the lamps 21a, 21b, 21c, and 21d, which generate heat when emitting light, it is preferable that the lamps 21a, 21b, 21c, and 21d be arranged so that their optical axes L1 and L2 are not oriented in the vertical direction. In other words, it is preferred that the optical axes L1 and L2 extend in the horizontal direction. In the present embodiment, the optical axis L3 of the projection lens 29 is orthogonal to the optical axes L1 and L2 of the lamps 21a, 21b, 21c, and 21d. Thus, the direction of the optical axis L3 (optical direction of the projection lens 29) may be changed while keeping the optical axes L1 and L2 horizontal to display an image on a screen or wall located in front, behind, or beside the projector 1. For example, the projector 1 may be arranged so that its lower surface 10e faces toward a horizontal surface or ceiling to display an image on a screen or wall. The projector 1 may also be arranged so that its lower surface 10e faces toward a wall to display an image on the floor or ceiling.

The projector 1 of the present embodiment is a four-lamp, three-LCD type LCD projector that displays a single image with four light sources. In addition to the optical components described above, the housing 10 accommodates electronic components (not shown), which drive liquid crystal panels of the liquid crystal light valves 27r, 27g, and 27b, and an intake fan (not shown), which cools the optical components and electronic components.

The projector 1 includes an air filter device 3 (refer to FIG. 1). The air filter device 3 draws ambient air into the housing 10 to cool the optical components and captures dust from the air flowing into the housing 10. In the description hereafter, the direction oriented into the housing 10 will be referred to as an inward direction, and the direction oriented out of the housing 10 will be referred to as an outward direction.

As shown in FIG. 4, the air filter device 3 is coupled to the lower surface 10e of the housing 10. The air filter device 3 is drawn out from the front surface 10a of the housing 10 for removal from the projector 1. The air filter device 3 may be coupled to or removed from the projector 1 by moving the air filter device 3 in the longitudinal direction.

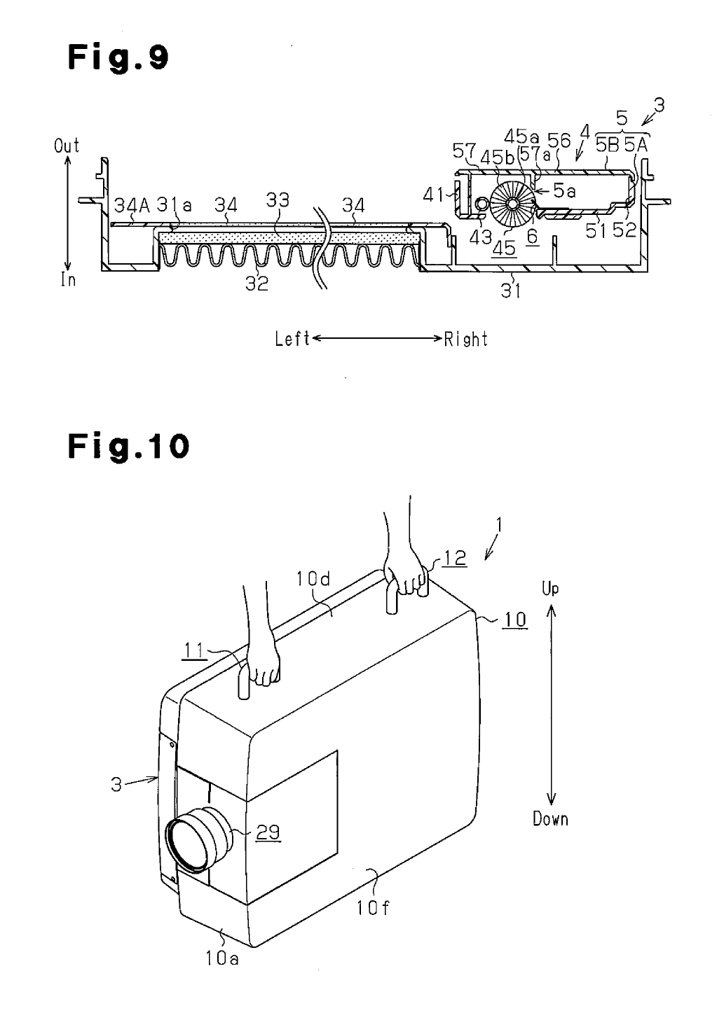

The air filter device 3 includes a base 31, which is formed from a resin material. The base 31 includes a tetragonal opening 31a, which serves as an air inlet. An electrostatic filter 32 is arranged on the base 31 to cover the opening 31a. The opening 31a is further covered by a urethane filter 33 (refer to FIG. 9) in the same manner as the electrostatic filter 32. The urethane filter 33 is an air filter formed from urethane.

The electrostatic filter 32 has a corrugated cross-section and is formed from electrostatic fibers. The electrostatic filter 32 and urethane filter 33 are elastically deformable and embedded in the base 31. For example, the electrostatic filter 32 and urethane filter 33 are held by tabs 31b, which are formed integrally with the base 31. This prevents separation of and the filters 32 and 33 from the base 31.

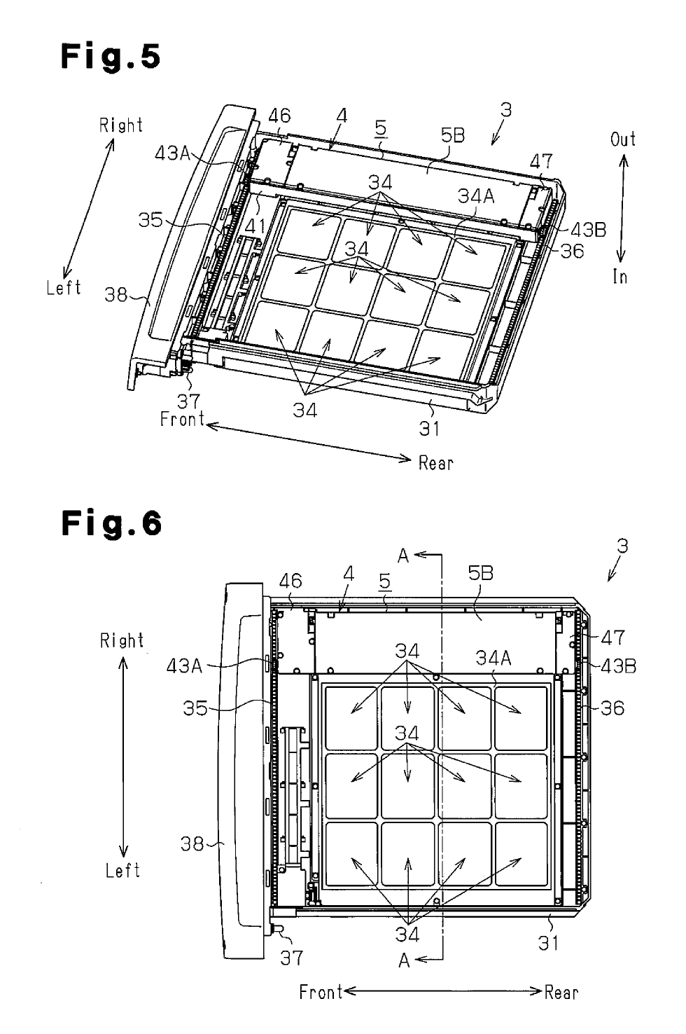

FIG. 5 is a perspective view showing the air filter device 3 of FIG. 4 in a state reversed upside down. FIG. 6 is a plane view showing the air filter device 3 as viewed from the outer side.

As shown in FIGS. 5 and 6, the air filter device 3 includes an air filter 34, which is arranged outward from the electrostatic filter 32 and urethane filter 33. The air filter 34 is adhered or fused to a grid 34A. The grid 34A is fastened by screws to the base 31 so that the air filter 34 is arranged on the base 31 covering the opening 31a.

First and second racks 35 and 36 are fastened by screws to the base 31. The first rack 35 extends in the lateral direction and is arranged frontward from the air filter 34. The second rack 36 extends in the lateral direction and is arranged rearward from the air filter 34. The air filter device 3 is moved on the racks 35 and 36 when coupled to or removed from the projector 1. In this manner, the two racks 35 and 36 are arranged parallel to each other at opposite sides of the air filter 34.

A connector 37 is arranged on a front part of the base 31 for connection with a connector (not shown) of the projector 1. When the air filter device 3 is coupled to the projector 1, the connector 37 is connected to the connector of the projector 1. Connection of the connector 37 with the connector of the projector 1 supplies power from the projector 1 to the electrical components of the air filter device 3.

A panel 38 is coupled to the front of the base 31. The panel 38 is flush with the front of the housing 10 so that the housing 10 has a continuous surface.

When the air filter device 3 is coupled to the projector 1, a triple-layer air filter is formed by the air filter 34, the electrostatic filter 32, and the urethane filter 33.

The air filter device 3 includes a cleaning unit 4, which automatically cleans the air filter 34. The air filter device 3 serves as an air filter cleaner, which includes the air filter 34 and a cleaning unit 4. The cleaning unit 4 is, for example, generally box-shaped. When the cleaning unit 4 is not cleaning the air filter 34, the cleaning unit 4 is separated from the air filter 34 as viewed from outward and inward directions.

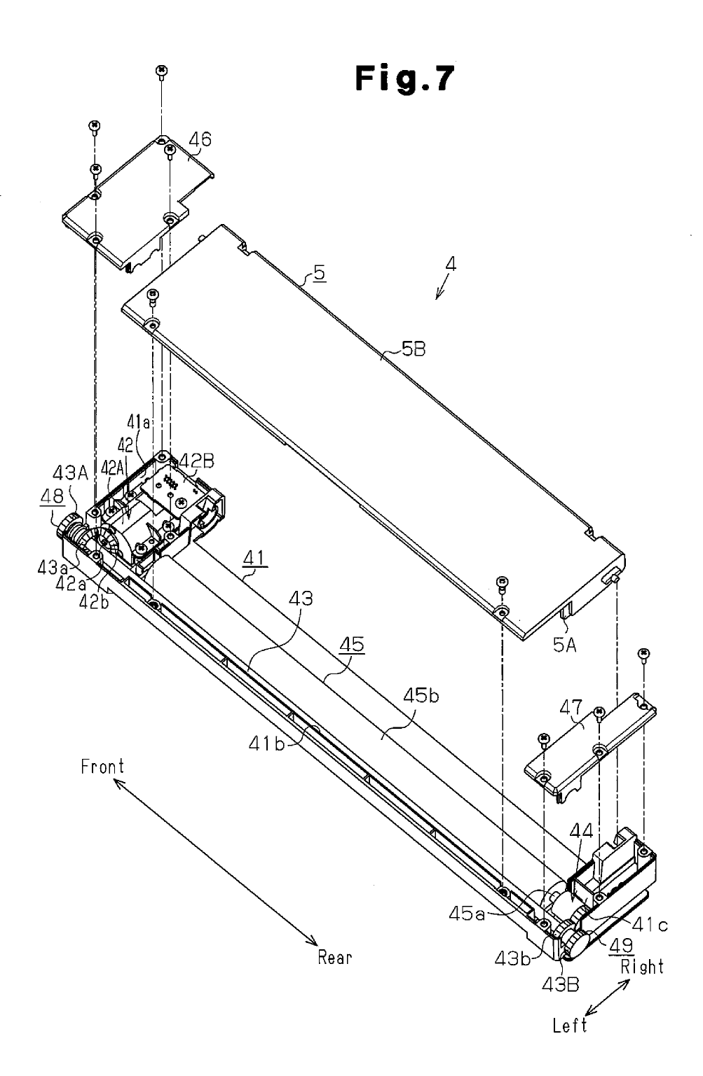

FIG. 7 is an exploded perspective view showing the cleaning unit 4 of FIG. 5.

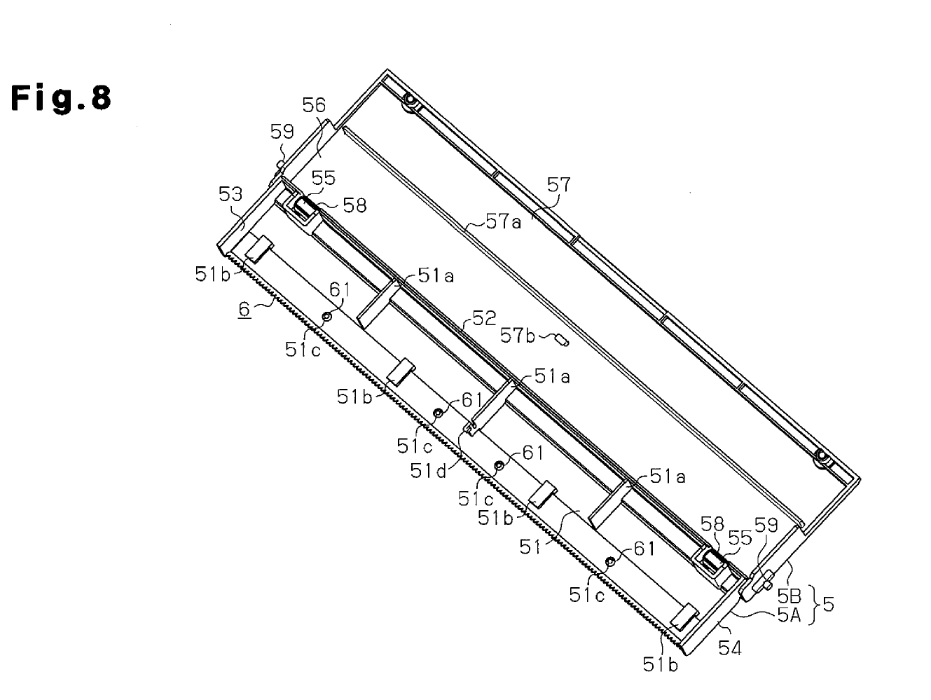

As shown in FIG. 7, the cleaning unit 4 includes a case 41, covers 46 and 47, a brush 45, and a dust box 5. The covers 46 and 47 are fastened by screws to the case 41. The brush 45 cleans the air filter 34. The dust box 5 collects dust from the brush 45 and is fastened by screws to the case 41. FIG. 8 is a perspective view showing the dust box 5 in an open state. FIG. 9 is a cross-sectional view taken along line A-A in FIG. 6. As shown in FIGS. 8 and 9, the cleaning unit 4 further includes a dust remover 6, which removes dust from the brush 45.

As shown in FIG. 7, the case 41 is elongated in the longitudinal direction. A motor compartment 41a is arranged in the front part of the case 41. A compact motor 42 is accommodated in the motor compartment 41a. A rotary shaft compartment 41b is arranged in the left part of the case 41 extending from the front part to the rear part of the case 41. The rotary shaft compartment 41b accommodates a rotary shaft 43, which is rotated by the motor 42.

A power transmission mechanism compartment 41c is arranged at the rear part of the case 41. The power transmission mechanism compartment 41c accommodates a power transmission mechanism 44, which transmits the rotation of the rotary shaft 43 to the brush 45. The motor compartment 41a and the power transmission mechanism compartment 41c are spaced apart from each other in the longitudinal direction of the case. In other words, a gap is formed between the motor compartment 41a and the power transmission mechanism compartment 41c in the case 41. The brush 45 and the dust box 5 are arranged in this gap at the right side of the rotary shaft compartment 41b.

The motor 42, which is accommodated in the motor compartment 41a, serves as the power source of the cleaning unit 4. A motor cover 42A is fastened by screws to the case 41 to cover the motor 42. The motor 42 includes an output shaft 42a. A bevel gear 42b is arranged on a distal end of the output shaft 42a. The motor 42 rotates the bevel gear 42b when supplied with power via the connector 37 from the projector 1. The output shaft 42a of the motor 42 extends leftward. The bevel gear 42b is arranged in the rotary shaft compartment 41b. In the rotary shaft compartment 41b, the bevel gear 42b is engaged with a bevel gear 43a arranged on the rotary shaft 43.

A printed wiring board 42B, which supplies the motor 42 with power, is accommodated in the motor compartment 41a. In the present example, the motor 42 moves integrally with the case 41 in the lateral direction. It is thus preferable that a film-like flexible cable (not shown) be connected to the printed wiring board 42B. That is, it is preferable that the motor 42 be connected to the connector 37, which is arranged on the base 31, by a film-like flexible cable (not shown).

The rotary shaft 43, which is accommodated in the rotary shaft compartment 41b, is formed from a metal material and arranged extending in the longitudinal direction in the case 41. In addition to the bevel gear 43a, which is engaged with the bevel gear 42b, a spur gear 43b, which is connected to the power transmission mechanism 44, is arranged on the rotary shaft 43. The motor 42 rotates the rotary shaft 43 with the bevel gears 42b and 43a. The spur gear 43b of the rotary shaft 43 transmits torque from the motor 42 to the power transmission mechanism 44.

A first pinion 43A is arranged on the front end of the rotary shaft 43. A second pinion 43B is arranged on the rear end of the rotary shaft 43. The pinions 43A and 43B may be formed from a resin material. The first pinion 43A projects frontward from the case 41. The second pinion 43B projects rearward from the case 41. The first and second pinions 43A and 43B are respectively engaged with the first and second racks 35 and 36. When the motor 42 generates rotation with the rotary shaft 43, the engagement of the racks 35 and 36 with the pinions 43A and 43B move the cleaning unit 4 leftward and rightward.

The bevel gear 43a and the first pinion 43A may be formed as a single resin member 48 that has superior wear resistance. The spur gear 43b and the second pinion 43B may also be formed as a single resin member 49 that has superior wear resistance. The resin member 48 includes an intermediate collar between the bevel gear 43a and the first pinion 43A. The intermediate collar is supported by the front end of the case 41. In the same manner, the resin member 49 includes an intermediate collar between the spur gear 43b and the second pinion 43B. The intermediate collar is supported by the rear end of the case 41. In this manner, the case 41 supports the rotary shaft 43 in a rotatable manner. Further, the rotary shaft 43 is supported in a rotatable manner by portions other than the front and rear ends of the case 41.

The power transmission mechanism 44, which is accommodated in the power transmission mechanism compartment 41c, includes a mechanical element engaged with the spur gear 43b. The power transmission mechanism 44 is connected to a shaft 45a of the brush 45 to transmit torque from the rotary shaft 43 to the brush shaft 45a. When the rotary shaft 43 of the motor 42 is rotated, the brush 45 is rotated. It is preferable that the power transmission mechanism 44 be formed by a one-way clutch that rotates the brush 45 only in the direction that collects dust in the dust box 5.

The brush shaft 45a is formed from a metal or resin material. The brush 45 includes bristles 45b, which extend radially outward from the shaft 45a. The case 41 supports the front and rear ends of the shaft 45a so that the brush 45 is rotatable. The bristles 45b partially extend out of the case 41. Accordingly, when the cleaning unit 4 moves facing toward the air filter 34, the brush 45 rotates to clean the air filter 34. This collects dust on the bristles 45b.

The cover 46 is fastened by screws to the front end of the case 41. The cover 46 covers the motor 42, printed wiring board 42B, and bevel gears 42b and 43a, which are arranged at the front part of the case 41. The case 41 and the cover 46 hold the rotary shaft 43 and the brush shaft 45a in a rotatable manner when fastened by screws to the case 41.

The cover 46 is fastened by screws to the rear end of the case 41. The cover 47 covers the spur gear 43b and the power transmission mechanism 44, which are arranged at the rear part of the case 41. By fastening the cover 47 with screws to the case 41, the case 41 and the cover 47 hold the rotary shaft 43 and the brush shaft 45a in a rotatable manner. In this manner, the case 41 and the covers 46 and 47 function as bearings of the rotary shaft 43 and the brush shaft 45a.

Referring to FIGS. 8 and 9, the dust box 5, which is arranged in the case 41, includes an inner case 5A and an outer case 5B. The cases 5A and 5B, which are formed from a resin material, are pivotally coupled to each other to allow the dust box 5 to open.

As shown in FIG. 8, the inner case 5A includes an inner wall 51, a right wall 52, a front wall 53, and a rear wall 54, which define a void in the dust box 5. The inner case 5A includes rods 55, which pivotally couple the cases 5A and 5B.

The inner wall 51 is located in the dust box 5 when the dust box 5 is coupled to the case 41 Partitions 51a extend from the inner wall 51 to partition the interior of the dust box 5 in the longitudinal direction. The partitions 51a prevent dust from being concentrated at the same location in the dust box 5 even when the longitudinal direction of the void in the dust box 5 extends vertically.

The dust remover 6 is arranged on the inner wall 51 to remove dust from the bristles 45b of the brush 45. Clips 51b and projections 51c are formed integrally with the inner wall 51 to couple the dust remover 6 to the inner wall 51. The projections 51c are fitted into holes 61 of the dust remover 6. The clips 51b restrict movement of the dust remover 6.

When the dust box 5 is coupled to the case 41, the right wall 52 extends outward from the right end of the inner wall 51 (refer to FIGS. 8 and 9). The right wall 52 is arranged at the right side of the dust box 5.

When the dust box 5 is coupled to the case 41, the front wall 53 extends outward from the front end of the inner wall 51. The front wall 53 is arranged at the front side of the dust box 5 and connected to the right wall 52.

When the dust box 5 is coupled to the case 41, the rear wall 54 extends outward from the rear end of the inner wall 51. The rear wall 54 is arranged at the rear side of the dust box 5 and connected to the right wall 52.

The cylindrical rods 55 are arranged at opposite ends of the right wall 52 in the longitudinal direction of the dust box 5 (i.e., the longitudinal direction when the dust box 5 is coupled to the case 41).

The outer case 5B includes an outer wall 56, which forms a void in the dust box 5. The outer case 5B includes a brush cover 57, which covers the brush 45, rod supports 58, which pivotally support the cases 5A and 5B, and joints 59, which pivotally couple the dust box 5 to the case 41.

When the dust box 5 is coupled to the case 41, the outer wall 56 is located at the outer side of the dust box 5. The outer wall 56 includes a partition 57a, which partitions the void of the dust box 5 in the lateral direction. The partition 57a prevents dust from being released from the dust box 5.

A tongue 57b is arranged on the outer wall 56 to keep the inner case 5A and outer case 5B closed. When the inner case 5A and outer case 5B close, the tongue 57b engages with an extension 51d, which is arranged on the distal end of the middle partition 51a in the inner case 5A. This restricts pivoting of the outer case 5B relative to the inner case 5A.

A brush cover 57 extends from the outer wall 56 toward the brush 45. When the dust box 5 is coupled to the case 41, the brush cover 57 covers the rotary shaft 43 and the brush 45, which are arranged in the case 41. The brush cover 57 of the dust box 5 is fastened by screws to the case 41 to couple the dust box 5 to the case 41.

The rod supports 58 are arranged in correspondence with the rods 55, which are arranged at the two opposite ends in the longitudinal direction of the dust box 5. The rod supports 58 of the outer case 5B support the rods 55 of the inner case 5A. This pivotally couples the cases 5A and 5B to each other.

The joints 59 are arranged on the front and rear ends of the outer case 5B. Each joint 59 includes an elliptical projection and a cylindrical boss projecting outward from the boss. The case 41 supports the joints 59 when the dust box 5 is coupled to the case 41.

The dust box 5 is formed by the inner wall 51, the right wall 52, the front wall 53, the rear wall 54, and the outer wall 56. Further, the dust box 5 includes an elongated opening at the left side. That is, as shown in FIG. 9, when the dust box 5, which collects dust, is coupled to the case 41, an opening 5a is formed in the dust box 5 facing toward the brush 45. The opening 5a of the dust box 5 extends in the longitudinal direction of the case 41 and is formed to collect dust from the bristles 45b of the brush 45.

The dust remover 6 is coupled to the dust box 5 in the opening 5a. More specifically, the dust remover 6 is arranged on the left end of the inner case 5A. As shown in FIG. 9, when the dust box 5 is coupled to the case 41, the dust remover 6 is arranged to card the bristles 45b of the brush 45. Accordingly, rotation of the brush 45 removes dust from the bristles 45b of the brush 45. The left edge of the dust remover 6 is saw-toothed. Thus, the dust remover 6 effectively removes dust from the brush 45.

When the cleaning unit 4 shown in FIG. 9 moves leftward, the rotating brush 45 cleans the air filter 34, and the brush 45 on the brush 45 enters the dust box 5 through the opening 5a. This keeps dust in the dust box 5. When the cleaning unit 4 moves to the left end of the base 31 and completes cleaning, the cleaning unit 4 moves toward the right. In this manner, the cleaning unit moves back and forth leftward and rightward to clean the air filter 34.

The dust box 5 opens in a direction that is the same as the direction in which the optical axes L1 and L2 of the lamps 21a, 21b, 21c, and 12d extend. Thus, when the optical axes L1 and L2 are parallel to the horizontal direction, the dust box 5 is open in the horizontal direction. In this case, dust is not released from the dust box 5.

As described above, the projector 1 includes the housing 10, to which the air filter 34 can be coupled, the brush 45, which moves in the lateral direction that is a predetermined linear direction to clean the air filter 34, the dust box 5, which opens toward the brush 45 to collect dust from the brush 45, and the handles 11 and 12, which are arranged on the housing 10.

In the present embodiment, the handles 11 and 12 are arranged on the housing 10 so that when the handles 11 and 12 are held to carry the housing 10, the opening 5a of the dust box 5 is oriented in an upward direction.

When the projector 1 is arranged on a horizontal surface, one grasps the handles 11 and 12 to tilt the projector 1 and then lift the housing 10 so that the grasped handles 11 and 12 are located above the center of gravity of the projector 1.

FIG. 10 shows a state in which the handles 11 and 12 are grasped to lift the housing 10. FIG. 11 schematically shows the direction in which the dust box 5 is open when the housing 10 is lifted as shown in the state of FIG. 10.

As shown in FIG. 11, the grips 11b and 12b of the handles 11 and 12 are arranged in the direction in which the dust box 5 opens (i.e., leftward direction). By arranging the handles 11 and 12 on the left side surface 10d, the handles 11 and 12 are located toward the left from the opening 5a of the dust box 5. In this structure, when holding the handles 11 and 12 to lift the housing 10, the opening 5a of the dust box 5 is oriented upward.

The projector 1 of the first embodiment has the advantages described below.

(1) The handles 11 and 12 are arranged on the housing 10 so that the opening 5a of the dust box 5 is oriented upward when one grips the handles 11 and 12 to lift the housing 10. Thus, one may grip the handles 11 and 12 to carry the projector 1 in a state in which the opening 5a of the dust box 5 is oriented upward. Accordingly, when the projector 1 is carried, dust is not released through the opening 5a from the dust box 5.

(2) The handles 11 and 12 are arranged on only the side surface 10d of the housing 10. Accordingly, when using the handles 11 and 12 to lift the housing 10, the opening 5a of the dust box 5 is oriented upward. If another handle were to be arranged on another side surface of the housing 10, it would be difficult for the user to recognize the handle that should be gripped to orient the opening 5a of the dust box 5 in an upward direction. Accordingly, in comparison to when handles are arranged on the two side surfaces 10c and 10d, the arrangement of handles on only the side surface 10d of the housing 10 decrease the possibility of the housing 10 being lifted in a state in which the opening 5a of the dust box 5 is oriented downward.

(3) The handles 11 and 12 include the grips 11b and 12b, which extend orthogonal (in the longitudinal direction) to the direction in which the dust box 5 is open. That is, the grips 11b and 12b extend in the horizontal direction. Thus, by grasping the grips 11b and 12b of the handles 11 and 12 to lift the housing 10, the projector 1 may be carried in a state in which the opening 5a of the dust box 5 is oriented upward.

(4) The two handles 11 and 12 are arranged on the single side surface 10d. This is more convenient than when lifting the housing 10 in comparison to when only one handle is arranged on the single side surface 10d.

(5) The handles 11 and 12 are located on the housing 10 in a direction in which the dust box 5 is open. Thus, by lifting the housing 10 with the handles 11 and 12 located above the dust box 5, the opening 5a of the dust box 5 is oriented upward.

### Second Embodiment

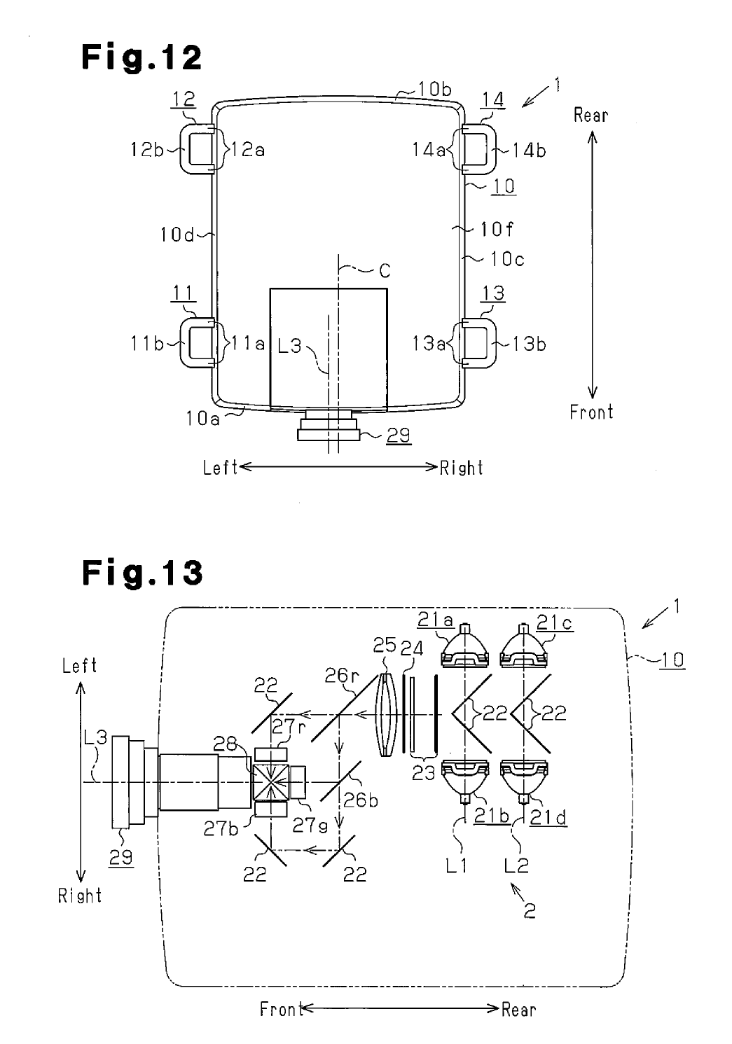

A projector 1 according to a second embodiment of the present invention will now be described with reference to FIGS. 12 and 13. Like or same reference numerals are given to those components that are the same as the corresponding components of the first embodiment. Such components will not be described in detail.

In the second embodiment, handles 13 and 14 are arranged on the side surface 10c in addition to the handles 11 and 12 arranged on the side surface 10d. In the present example, the handle 13 includes two extensions 13a, which extend rightward from the side surface 10c of the housing 10, and a grip 13b, which connects the two extensions 13a. Further, the handle 14 includes two extensions 14a, which extend rightward from the side surface 10c of the housing 10, and a grip 14b, which connects the two extensions 14a. Accordingly, the grips 13b and 14b of the handles 13 and 14 extend in the longitudinal direction of the projector 1.

The handles 13 and 14 may be formed integrally with the housing 10 from the same material as the housing 10. Alternatively, the handles 13 and 14 may be formed from a material that differs from that of the housing 10 so that they may be coupled in a removable manner to the housing 10 or retracted into the housing 10. Further, the handles 13 and 14 do not have to be directly arranged on the housing 10.

In the same manner as in the first embodiment, the handles 11 and 12 are arranged on the housing 10 so that the opening 5a of the dust box 5 is oriented upward when the handles 11 and 12 are grasped to lift the housing 10. Accordingly, the handles 13 and 14 are arranged on the housing 10 so that the opening 5a of the dust box 5 is oriented downward when the handles 13 and 14 are grasped to lift the housing 10.

The handles 13 and 14 are spaced apart from each other in the longitudinal direction of the projector 1. When the projector 1 is carried by two persons, one person holds the grips 11b and 12b of the handles 11 and 12 with both hands, and the other person holds the grips 13b and 13b of the handles 13 and 14 with both hands. This allows for the projector 1 to be easily carried. In this state, the opening 5a of the dust box 5 extends in the horizontal direction. Thus, the opening 5a of the dust box 5 is not oriented downward when the projector 1 is carried.

When a single person carries the projector 1, for the opening 5a of the dust box 5 to be oriented upward, the handles 11 and 12, not the handles 13 and 14, should be grasped when lifting the housing 10. Thus, the projector 1 of the second embodiment includes an indication to indicate that the handles 11 and 12 are to be preferentially grasped over the handles 13 and 14.

For example, the projection lens 29 serves as the indication. The projection lens 29 is formed so that its optical axis L3 is deviated from the center line C of the housing 10 toward the handles 11 and 12. This indicates to the user that the handles 11 and 12 should be preferentially grasped over the handles 13 and 14. The center line C of the housing 10 bisects the projector 1 in the lateral direction so that the side surface 10c and the side surface 10d are equally distanced from to the center line C. The optical axis L3 of the projection lens 29 is located leftward from the center line C of the housing 10.

As shown in FIG. 13, the optical system 2 is entirely arranged toward the left as compared with the optical system 2 of the first embodiment shown in FIG. 3. Thus, in the second embodiment, the optical axis L3 of the projection lens 29 is deviated toward the left from the center line C.

In addition to advantages (1), (2), (4), and (5) of the first embodiment, the projector 1 of the second embodiment has the advantages described below.

(6) In addition to the handles 11 and 12 arranged on the side surface 10d of the housing 10, the handles 13 and 14 are arranged on the side surface 10c of the housing 10. Thus, for example, when only the handles 11 and 12 are arranged on the handles 11 and 12, the projector 1 is easily carried by two persons.

(7) The projector 1 includes the projection lens 29, which serves as an indication to indicate to the user that the handles 11 and 12 should be preferentially grasped over the handles 13 and 14. Thus, by determining the location of the projection lens 29, the user can easily recognize the handles 11 and 12 that should be grasped to orient the opening of the dust box 5 upward. Accordingly, even when the projector 1 includes the handles 13 and 14, the user can carry the projector 1 with the opening 5a of the dust box 5 directed in an upward direction. Thus, dust is not released from the dust box 5 through the opening 5a when the projector 1 is carried.

(8) The projection lens 29, which serves as an indication, is arranged on the housing 10 so that the optical axis L3 is deviated from the center line C of the housing 10 toward the handles 11 and 12. In this case, the person who will carry the projector 1 will most likely assume that the center of gravity of the projector 1 is also deviated from the center line C of the housing 10 toward the handles 11 and 12. To suppress swinging of the projector 1 when carrying the projector 1, it is preferable that the grasped handles be close to the center of gravity of the projector 1. Accordingly, based on the location of the projection lens 29, the person who will carry the projector 1 can be expected to grasp the handles 11 and 12 preferentially over the handles 13 and 14 to lift the housing 10. Thus, by using the projection lens 29 as an indication, the user can easily the handles 11 and 12, which are optimal for carrying the projector 1.

### Third Embodiment

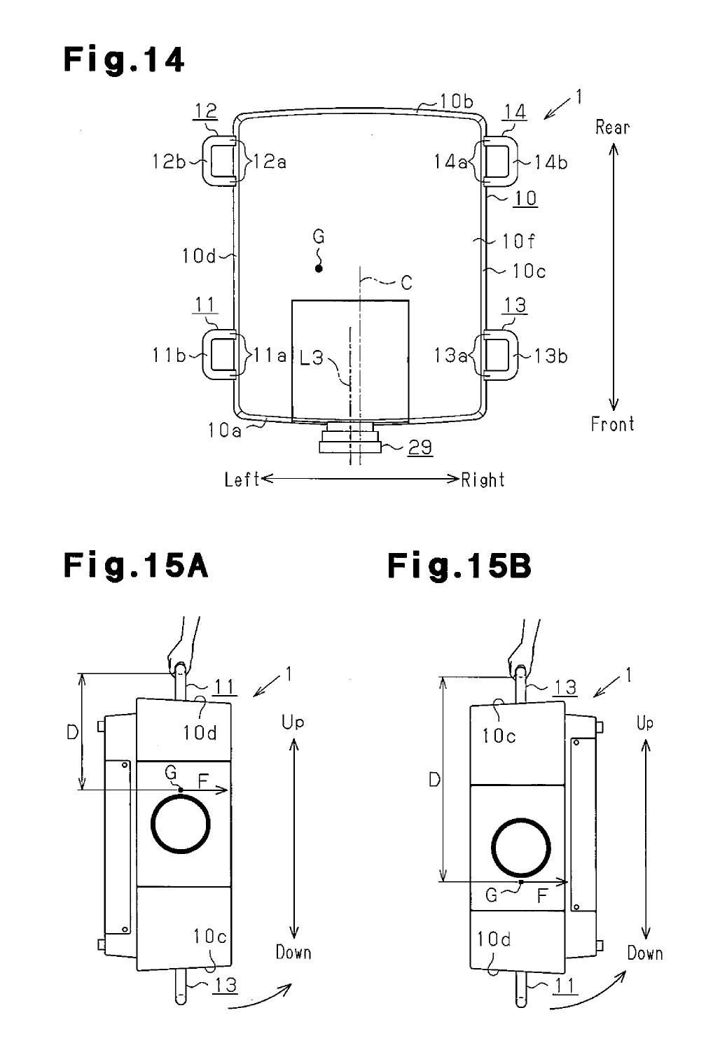

A projector according to a third embodiment of the present invention will now be described with reference to FIGS. 14 and 15. Like or same reference numerals are given to those components that are the same as the corresponding components of the first embodiment. Such components will not be described in detail.

As shown in FIG. 14, in the third embodiment, the projector 1 has a center of gravity C that is located closer to the handles 11 and 12 than the handles 13 and 14. In other words, the center of gravity G of the projector 1 is located leftward from the center line C of the housing 10.

In the third embodiment, the projection lens 29 is located leftward from the center line C of the housing 10 in the same manner as the second embodiment. More specifically, the projection lens 29 is arranged so that its optical axis L3 is deviated from the center line C of the housing 10 toward the handles 11 and 12.

In addition to advantages (1), (2), (4), and (5) of the first embodiment and advantage (6) of the second embodiment, the projector 1 of the third embodiment has the advantages described below.

(9) The center of gravity C of the projector 1 is located closer to the handles 11 and 12 than the handles 13 and 14. Accordingly, as shown in FIGS. 15A and 15B, when grasping the handles 11 and 12 to lift the housing 10, the distance from the grasped handles 11 and 12 to the center of gravity G is shorter than when grasping the handles 13 and 14 to lift the housing 10. When a force F that swings the projector 1 acts on the center of gravity G, the moment of the force acting about the grasped handles 11 and 12 is smaller than that when the handles 13 and 14 are grasped. Thus, to suppress swinging of the projector 1 when carrying the projector 1, it is preferable that the handles 11 and 12 be grasped to lift the housing 10. From this viewpoint, when someone carries the projector 1, that person is likely to hold the handles 11 and 12 taking into consideration the location of the center of gravity G. When grasping the handles 11 and 12 to lift the housing 10, the opening 5a of the dust box 5 is oriented upward. Thus, in comparison to when the center of gravity G is located near the handles 13 and 14, there is a higher probability of the housing 10 being lifted with the opening 5a of the dust box 5 being oriented upward. As a result, when carrying the projector 1, the dust collected in the dust box 5 is less likely to escape from the opening 5a.

(10) The projection lens 29 is arranged on the housing 10 to that its optical axis L3 is deviated from the center line C of the housing 10 toward the handles 11 and 12. Thus, the user can recognize from the location of the projection lens 29 that the center of gravity G of the projector 1 is deviated from the center line C.

(11) Referring to FIG. 15A, the center of gravity G of the projector 1 and the handles 11 and 12 lie along a plane parallel to the direction in which the dust box 5 opens (vertical direction as viewed in FIG. 15A). Thus, by grasping the handles 11 and 12, which are located right above the center of gravity G in the parallel plane, the opening 5a of the dust box 5 is oriented upward.

It should be apparent to those skilled in the art that the present invention may be embodied in many other specific forms without departing from the spirit or scope of the invention. Particularly, it should be understood that the present invention may be embodied in the following forms.

In the second and third embodiments, the shapes and layout of the handles 13 and 14 may be changed as required. Further, one of the handles 13 and 14 may be eliminated. In other words, the side surface 10c may be provided with just one handle. In this case, it is preferable that the handle be arranged on the side surface 10c so as to lie along the same plane as the gravity of the projector 1, in which the plane extends parallel to the lateral direction.

The shapes and layout of the handles 11 and 12 may be changed as required. Further, one of the handles 11 and 12 may be eliminated. In other words, the side surface 10d may be provided with just one handle. In this case, it is preferable that the handle be arranged on the side surface 10d so as to lie along the same plane as the gravity of the projector 1, in which the plane extends parallel to the lateral direction.

In each of the embodiments described above, the handles 11 and 12 are arranged so that the opening 5a of the dust box 5 is oriented in the upward direction as viewed in, for example, FIG. 10. However, as long as the dust collected in the dust box 5 is not released through the opening 5a, the handles 11 and 12 do not have to be arranged so that the opening 5a of the dust box 5 is oriented in the upward direction.

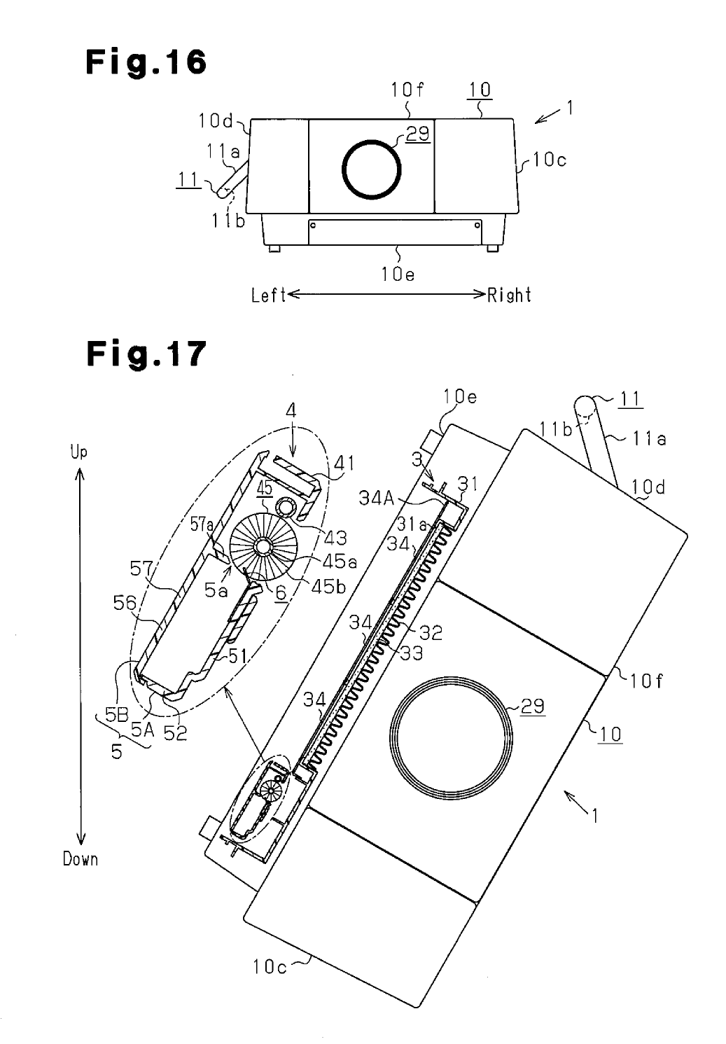

For example, as shown in FIG. 16, the extensions 11a of the handle 11 may extend obliquely from the side surface 10d. When this handle 11 is grasped to lift the housing 10, as shown in FIG. 17, the opening 5a of the dust box 5 is oriented in an oblique direction relative to the upward direction indicated by the arrow. Even when the opening 5a of the dust box 5 is oriented in an oblique upward direction, the advantages of the above embodiments are obtained. Accordingly, in the present invention, the upward direction is not limited to a direction orthogonal to the horizontal direction and includes oblique upward directions.

The air filter device 3 may be arranged on the left side of the projector 1 instead of the right side. Further, the air filter device 3 may be arranged on the rear side of the projector 1 instead of the front side. Accordingly, the dust box 5 does not have to be open toward the left in the lateral direction.

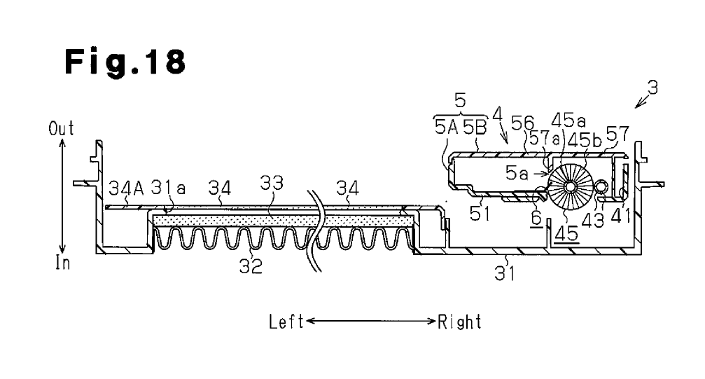

For example, as shown in FIG. 18, in the air filter device 3 of each embodiment, the cleaning unit 4 may be arranged on the right side instead of the left side. In this case, the dust box 5 opens toward the right. Thus, handles are arranged on the side surface 10c. Further, the direction in which the dust box 5 opens is not limited to the leftward or rightward direction.

The handles are not limited to the handles 11, 12, 13, and 14 arranged on the side surfaces 10c and 10d. More specifically, the side surface refers to any exposed outer surface of the housing 10 and may be front surface 10a or the rear surface 10b. Thus, for example, when the dust box 5 opens toward the rear, a handle may be arranged on the rear surface 10b.

In the embodiments described above, the air filter 34 is cleaned by the movable brush 45. However, a movable air filter (not shown) may be cleaned by a fixed brush. In other words, as long as the air filter can be cleaned by a brush, the brush does not have to move.

The present invention is not limited to a video projector including four light sources. The present invention may also be applied to a video projector including only one light source or at least two light sources. Further, the video projector is not limited to an LCD projector and may be a video projector that uses a digital micromirror device (DMD) to display an image.

The present examples and embodiments are to be considered as illustrative and not restrictive, and the invention is not to be limited to the details given herein, but may be modified within the scope and equivalence of the appended claims.

1. A video projector comprising:
a housing to which an air filter is coupled in a removable manner;
a brush that cleans the air filter;
a dust box that collects dust from the brush and includes an opening that opens toward the brush; and
a handle arranged on the housing so that the opening of the dust box is oriented upward when the handle is grasped to lift the housing.

2. The video projector according to claim 1, wherein the housing includes a plurality of side surfaces, and the handle is arranged on one of the side surfaces.

3. The video projector according to claim 1, wherein the handle includes a grip that extends in a direction orthogonal to the direction in which the opening of the dust box opens.

4. The video projector according to claim 1, wherein the handle is one of a plurality of handles arranged on the housing.

5. The video projector according to claim 1, wherein the handle is located in the direction in which the opening of the dust box opens.

6. A video projector comprising:
a housing to which an air filter is coupled in a removable manner;
a brush that cleans the air filter;
a dust box that collects dust from the brush and includes an opening that opens toward the brush;
a plurality of handles arranged on the housing, wherein the plurality of handles include at least one first handle and at least one second handle, and the at least one first handle is arranged on the housing so that the opening of the dust box is oriented upward when the at least one first handle is grasped to lift the housing; and
an indication that indicates that the at least one first handle to be preferentially grasped over the at least one second handle.

7. The video projector according to claim 6, further comprising a projection lens that includes an optical axis and projects light of an image about the optical axis, wherein:
the housing includes a plurality of side surfaces, and the at least one first handle is arranged on a predetermined one of the side surfaces, and the at least one second handle is arranged on a further one of the side surfaces;
the housing includes a center line located so that the predetermined one of the side surfaces and the further one of the side surfaces are equally distanced from the center line;
the projection lens is arranged on the housing so that the optical axis is deviated from the center line of the housing toward the at least one first handle; and
the projection lens serves as the indication.

8. The video projector according to claim 6, wherein the at least one first handle includes two handles.

9. The video projector according to claim 6, wherein the at least one first handle is located in the direction in which the opening of the dust box opens.

10. A video projector comprising:
a housing to which an air filter is coupled in a removable manner;
a brush that cleans the air filter;
a dust box that collects dust from the brush and includes an opening that opens toward the brush;
a plurality of handles arranged on the housing, wherein the plurality of handles include at least one first handle and at least one second handle, the at least one first handle is arranged on the housing so that the opening of the dust box is oriented upward when the at least one first handle is grasped to lift the housing, and the at least one second handle is arranged on the housing so that the opening of the dust box is oriented downward when the at least second one second handle is grasped to lift the housing;
wherein the video projector is formed so that its center of gravity is located closer to the at least one first handle than the at least one second handle.

11. The video projector according to claim 10, further comprising a projection lens that includes an optical axis and projects light of an image about the optical axis, wherein:
the housing includes a plurality of side surfaces, and the at least one first handle is arranged on a predetermined one of the side surfaces, and the at least one second handle is arranged on a further one of the side surfaces;
the housing includes a center line located so that the predetermined one of the side surfaces and the further one of the side surfaces are equally distanced from the center line; and
the projection lens is arranged on the housing so that the optical axis is deviated from the center line of the housing toward the at least one first handle.

12. The video projector according to claim 10, wherein the center of gravity of the video projector and the at least one first handle lie along a plane parallel to the direction in which the opening of the dust box opens.

13. The video projector according to claim 10, wherein the at least one first handle includes two handles.

14. The video projector according to claim 10, wherein the at least one first handle is located in the direction in which the opening of the dust box opens.
